(19) United States
(12) Patent Application Publication
(10) Pub. No.: US 2013/0268615 A1
(43) Pub. Date: Oct. 10, 2013

(54) COMPUTER, COMPUTER SYSTEM, AND COMPUTER SYSTEM STARTING METHOD

(71) Applicant: HITACHI, LTD., Tokyo (JP)

(72) Inventors: Yoshihiro YUNOMAE, Tokyo (JP); Tomoki Sekiguchi, Tokyo (JP); Keisuke Hatasaki, Tokyo (JP)

(73) Assignee: HITACHI, LTD., Tokyo (JP)

(21) Appl. No.: 13/629,233

(22) Filed: Sep. 27, 2012

(30) Foreign Application Priority Data
Feb. 29, 2012 (JP) 2012-042753

(51) Int. Cl. H04L 29/08

(52) U.S. Cl. CPC H04L 67/1097
USPC 709/213

(57) ABSTRACT

A first server stores start administration information identifying a second server into a storage unit which stores an operating system to be started in the second server. The second server makes a decision whether a storage unit which is access set has start administration information identifying the second server stored therein If the storage unit which is access set is judged according to the decision to have start administration information identifying the second server stored therein the second server starts the operating system stored in the storage unit which is access set. If the storage unit which is access set is judged not to have start administration information identifying the second server stored therein, the second server deters from starting the operating system stored in the storage unit which is access set

### INCORPORATION BY REFERENCE

The present application claims priority from Japanese application JP 2012-042753 filed on Feb. 29, 2012, the content of which is hereby incorporated by reference into this application.

### BACKGROUND OF THE INVENTION

The present invention relates to a computer, a computer system, and a method for starting an operating system from a logical volume in a computer system.

A storage device which can be shared by a plurality of computers is widespread. The computers are connected to the storage device via a storage network. A network system configured in this way is called SAN (Storage Area Network).

The storage device stores logical volumes (LV) which are obtained by dividing a storage area logically. In the SAN, a computer accesses an LV as an external auxiliary storage device. In general, switches in the storage device and the storage network have an access control function from a computer to an LV. A computer can reference an LV which is set to access permission in the storage device.

In general, there are in the SAN a server administrator who administers a plurality of computers and a storage administrator who administers switches in the storage network. The server administrator conducts setting of a computer, computer power supply administration, maintenance of computer resources, and administration of operating systems (OSs) and applications executed on computers. On the other hand, the storage administrator conducts setting of a storage device, creation and removal of LVs, LV access permission setting, maintenance of storage device resources, and setting of a storage network.

The server administrator requests the storage administrator to give access permission of an LV to be referenced from a computer in order to start an OS from an LV which stores system information (such as an OS or applications). The storage administrator selects an object LV from a list of LVs stored in the storage device, and sets access permission of the LV to make it possible to refer to the LV from the computer. Thereafter, it becomes possible to start the OS.

According to JP-A-2009-199224, “lock data representing whether or not a Volume has been reserved for use as a system volume for OS starting is held in the volume. Before starting an OS, the computer writes data representing a system volume reservation as the lock data if the lock data held in the volume does not represent a system volume reservation, or stops accessing the volume if the lock data represents a system volume reservation.”

### SUMMARY OF THE INVENTION

When the storage administrator sets access permission for an LV in the SAN there is a possibility that the storage administrator might erroneously conduct permission setting of access to an LV which is not intended by the server administrator.

Although the server administrator grasps system information (such as an OS and applications) of LVs, it is difficult for the server administrator to know administration information of the LVs (such as administration numbers of the LVs and administration names of the LVs) in the storage device. On the other hand, although the storage administrator grasps administration information of the LVs, it is difficult for the storage administrator to know system information of the LVs. Even if the server administrator requests the storage administrator to set access permission to a certain LV in order to start an OS from a computer, therefore, it is possible that a situation where the LV desired by the server administrator differs from the LV which can be referenced from the computer occurs due to a design mistake or the like of the storage administrator.

In addition, since it is difficult for the server administrator to know what kind of system information is already stored in an LV which can be referenced, until the server administrator starts an OS, there is a possibility that the OS might be started from an LV which is different from an LV desired by the server administrator If an OS is started from an LV which is different from an LV intended by the server administrator, then it is necessary to execute processing for stopping a computer and request the storage administrator to set an LV again and consequently a quick shift of a system cannot be conducted. Furthermore, if the LV which is different from that intended by the server administrator is an LV which is being used in a different computer, the system area of the LV might be destroyed by starting an OS from that LV.

According to JP-A-2009-199224, starting an OS which is being used in another computer can be deterred. In JP-A-2009-199224, however, there is no description concerning a measure for ascertaining whether an LV which can be referenced from a computer is the same as an LV which stores an OS scheduled to be started in the computer.

The present invention has been achieved in order to solve the problem. In accordance with an aspect of the present invention, a computer system includes a storage unit connected to a plurality of computers, an operating system to be started in some computer being stored in the storage unit; a first computer having firmware which stores start administration information identifying the some computer into the storage unit; and a second computer having firmware for making a decision whether the storage unit which is accessed has start administration information identifying an on computer stored therein, the operating system stored in the accessed storage unit being started by the second computer, when the storage unit which is accessed is judged according to the decision to have start administration information identifying an own computer stored therein.

According to the present invention, a computer can start an OS certainly from an LV which stores an OS scheduled to be started and starting an OS from another LV can be deterred.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration example of a system in a first embodiment;

FIG. 2 is a diagram showing a configuration example of a host server in the first embodiment, a second embodiment, a third embodiment, and a fourth embodiment;

FIG. 3 is a flow chart of update processing of a volume administration area in the first embodiment;

FIG. 4 is a diagram showing a conception of data retained in a volume administration area in the first embodiment;

FIG. 5 is a flow chart of coincidence decision processing between a volume administration area and server unique information retained by a host server in the first embodiment;

FIG. 6 is a diagram showing a configuration example of a system the second embodiment;

FIG. 7 is a diagram showing a conception of data retained in a volume administration area in the second embodiment;

FIG. 8 is a flow chart of update processing of a start administration table in the second embodiment;

FIG. 9 is a diagram showing a conception of data retained in the start administration table in the second embodiment;

FIG. 10 is a flow chart of coincidence decision processing between a volume administration area and the start administration table retained by a host server in the second embodiment;

FIG. 11 is a diagram showing a configuration example of a system in the third embodiment;

FIG. 12 is a flow chart of update processing of a temporary administration buffer in the third embodiment;

FIG. 13 is a flow chart of update processing of a volume administration area in the third embodiment;

FIG. 14 is a flow chart of update processing of a start administration table in the third embodiment; and

FIG. 15 is a diagram showing a configuration example of a system in the fourth embodiment.

### DESCRIPTION OF THE EMBODIMENTS

Hereafter, embodiments will be described with reference to the drawings.

### First Embodiment

A first embodiment of the present invention will now be described. The first embodiment shows a configuration of an apparatus and a method having an effect of deterring start of an OS from an LV which is not scheduled to start the OS, by previously providing a logical volume (LV) which conducts starting with unique information (INF) of a host server scheduled to start the OS.

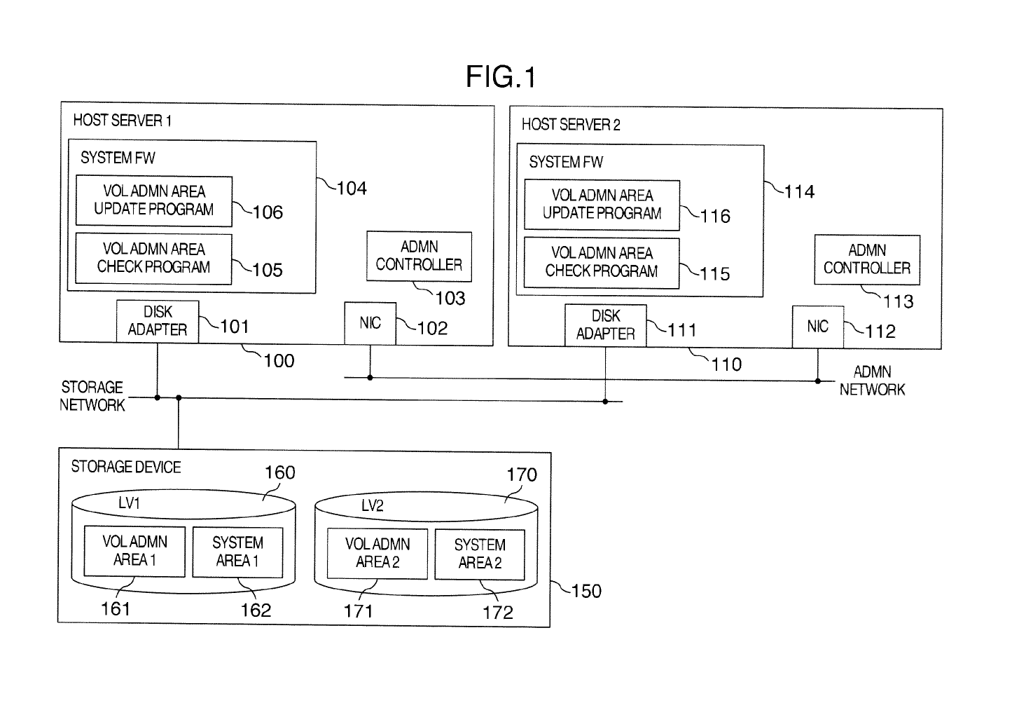

FIG 1 is a diagram showing a system configuration in the first embodiment. The system includes a host server (computer) 100, a host serve (computer) 110, and a storage device 150.

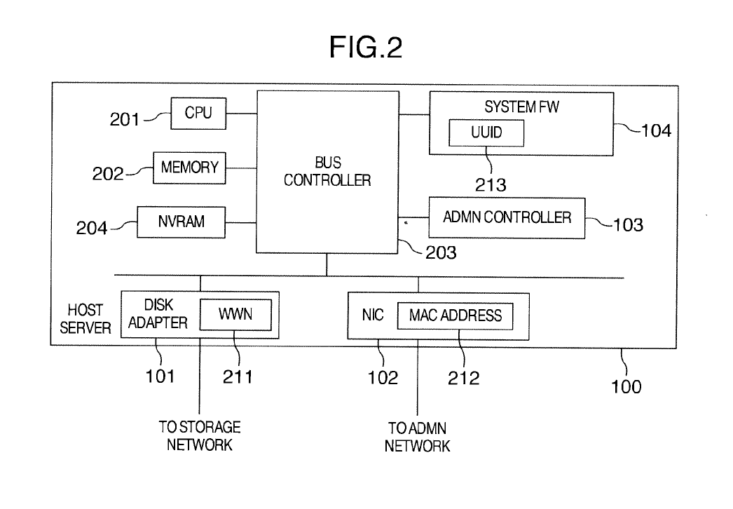

The host server 100 and the host server 110 are connected to an administration (ADMN) network to be capable of conducting communication by using network interface cards (NICs) 102 and 112 respectively mounted on them. Furthermore, the host server 100 and the host server 110 are connected to the storage device 150 via a storage network by using disk adapters 101 and 111 respectively mounted on them. The host server 100 and the host server 110 have the same configuration. A configuration in each host server will now be described with reference to FIG. 2.

FIG. 2 is a diagram showing a configuration of the host server 100. A CPU 201, a memory 202, an administration controller 103, system firmware (FW) 104, the disk adapter 101, the NIC 102, and an NVRAM (Non-volatile Random Access Memory) 204 are connected via a bus controller 203.

The system firmware 104 is mounted on a ROM (Read Only Memory) for firmware which is incorporated in the host server 100. The system firmware 104 is executed in he CPU 201.

The CPU 201 executes a start program for the system firmware 104, reads a specific area of an LV specified previously for starting by the server administrator into the memory, and executes starting of an OS stored in the LV.

In the ensuing description, an LV specified previously for starting by the server administrator is referred to as starting LV. The server administrator specifies a starting LV out of LVs which can be referenced on the system firmware in the host server. When the CPU 201 executes a program stored in the memory 202 or the system firmware 104 and takes some action, it will be represented in the ensuing description by an expression that the program executes the action.

The system firmware 104 is provided with a UUID (Universally Unique Identifier) 213 which is a unique ID for identifying a computer.

The disk adapter 101 is an interface card for connecting the host server 100 to the storage device 150 and making it possible for the host server 100 to access a specific LV in the storage device 150. The disk adapter 101 is provided with a WWN (World Wide Name) 211 which is a unique ID.

The NIC 102 is an interface card for communicating with another computer. The NIC 102 is provided with an MAC address 212 which is a unique ID.

The NVRAM 204 is used as a data area which can be read and written from the system firmware 104 and the administration controller 103. In the present embodiment, the NVRAM 204 may be connected to the bus controller 203 or may not be connected to it.

The administration controller 103 is a computer capable of executing firmware which monitors states of devices (the CPU 201, the memory 202, the system firmware 104, the disk adapter 101, the NIC 102, and the NVRAM 204) connected to the bus controller 203. Furthermore, the administration controller 103 retains information of the UUID 213 of the host server 100, the WWN 211 of the disk adapter 101, and the MAC address 212 of the NIC 102.

Start control processing from an LV conducted in a host server in the present embodiment will now be described. FIG. 1 is a diagram showing elements concerning the start control processing from an LV 160. FIG. 1 is a diagram showing configurations of the host servers 100 and 110, a configuration of the storage device 150, the administration network for connecting the host servers 100 and 110 to each other, and the storage network for connecting the host servers 100 and 110 to the storage device 150.

The storage device 150 includes two LVs 160 and 170 (storage units) to be used as system volumes (VOLs) by the host servers 100 and 110. Although two LVs are illustrated, one LV or three or more LVs may also be provided.

A system area 162 storing an OS and applications and a volume administration area 161 describing server unique information of a specific host server are stored in the LV 160.

In the same way, a system area 172 storing an OS and applications and a volume administration area 171 describing server unique information of a specific host server are stored in the LV 170.

It is also possible that the system areas 162 and 172 store OSs to be started in different host servers and the volume administration areas 161 and 171 store server unique information of the host servers which should start the OSs stored in the system areas 162 and 172, respectively.

Hereafter, the LV 160 will be described as a representative LV. As for the server unique information described in the volume administration area 161, any information will do as tong as it has unique values mounted on the host servers 100 and 110 and retained by the administration controllers 103 and 113. For example, paying attention to the host server 100 shown in FIG. 2, the server unique information described in the volume administration area 161 may be the UUID 213 of the system firmware 104, may be the MAC address 212 of the NIC 102, or may be the WWN 211 of the disk adapter 101.

Furthermore, contents described in the volume administration area 161 may be a combination of two among them, or may include all of them. In the ensuing description, it is supposed that unique values mounted on the host servers 100 and 110 are server unique information.

In the system firmware 104 and 114, volume administration area update programs 106 and 116 for updating the volume administration area 161 stored in the LV 160 and volume administration area check programs 105 and 115 which make a start decision with reference to the volume administration area 161 are stored.

In the ensuing description, a situation where an LV which has been used in a certain host server by the server administrator is used in a different host server is supposed. In the present embodiment, first, the LV itself is caused to previously retain information of a host server scheduled to start an OS. In addition, when actually starting an OS from the host server, the information retained by the LV is compared with information retained by the host server this way, it is prevented to start an OS from an LV which is not intended by the server administrator.

A procedure for the server administrator to update the volume administration area 161 in the LV 160 which can be referenced from the host server 110, by using the volume administration area update program 116 existing on the host server 110 will now be described. In the ensuing description, it is supposed that the server administrator previously retains server unique information of the host server 100 scheduled to start an OS. The server administrator can acquire server unique information fro e administration controller 103 in the host server 100.

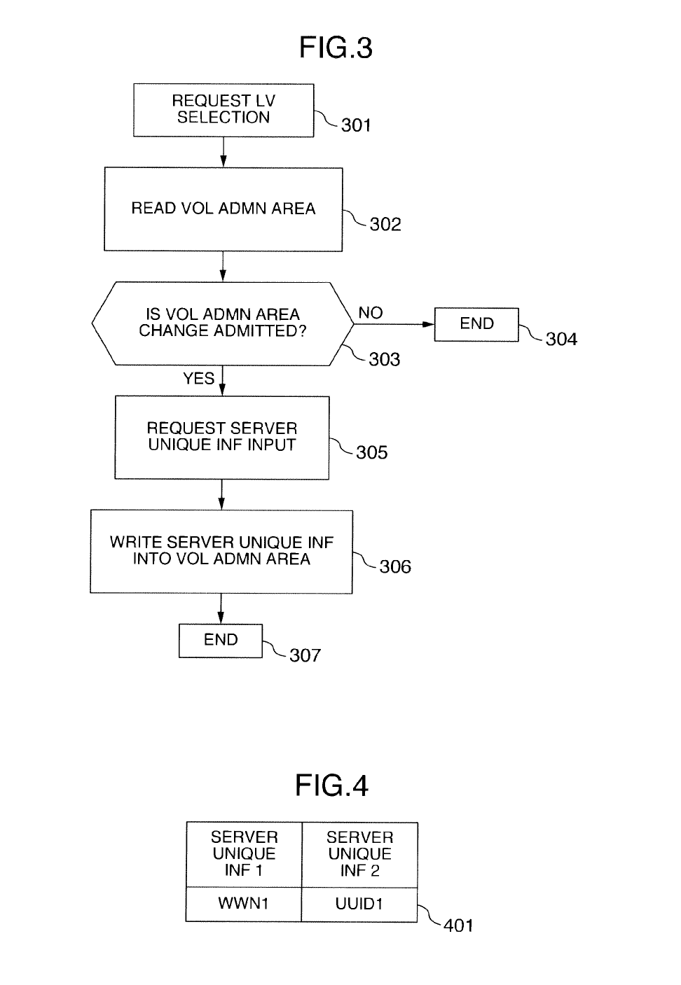

FIG. 3 shows a flow of the volume administration area update program 116.

The volume administration area update program 116 outputs a list of LVs which can be referenced from the host server 110 and outputs a selection unit for selecting an LV having a volume administration area to be updated. The server administrator may be caused to select an LV having a volume administration area to be updated (step 301). Since the LV 160 can be referenced from the host serer 110 here, the LV 160 is displayed.

The volume administration area update program 116 reads the volume administration area 161 stored in the LV 160 which is selected by using the selection unit for selecting an LV having a volume administration area to be updated. The LV 160 which is selected by using the selection unit may be an LV selected by the server administrator (step 302).

The volume administration area update program 116 outputs contents which are read, and outputs choices to ask whether the volume administration area 161 may be changed. The server administrator may be inquired of whether the volume administration area 161 may be changed (step 303).

If the change is rejected in the choices, for example, if the server administrator rejects the change, then execution of the volume administration area update program 116 is finished (step 304).

If the change is admitted in the choices, for example, if the server administrator admits the change, then the volume administration area update program 116 outputs an input unit for inputting the server unique information of the host server 100. The server administrator may be caused to input the server unique information of the host server 100 (step 305). Before causing the server administrator to input the server unique information, the server administrator may be caused to input an administration password.

Furthermore, the server administrator may be requested to input a memo. The server administrator may input any information such as a date of starting an OS and a caution at the time of use to the memo. Owing to existence of this memo, the server administrator can make a decision easily whether the volume administration area may be changed, when the contents of the volume administration area are output at the step 303. However, this memo is not used for coincidence comparison of server unique information at step 505 which will be described later.

The volume administration area update program 116 overwrites the server unique information which is input from the input unit at the step 305, on the volume administration area 161. The server unique information which is input from the input unit may be server unique information which is input by the server administrator (step 306).

It is output that writing the server unique information has been completed and the execution of the volume administration area update program 116 is finished (step 307).

FIG. 4 shows a content example 401 of server unique information described in the volume administration area 161. As server unique information of the host server 100, WWN1 (WWN 211) and UUID1 (UUID 213) are stored.

When the host server 100 conducts starting from the LV 160 which can be referenced for starting, server unique information of the host server 100 which is about to start an OS is compared with server unique information stored in the volume administration area 161 and start control of the LV 160 is exercised. This flow will now be described.

Upon turning on of power supply to the host server 100, the host server 100 conducts start processing such as initialization of connected devices, then reads the volume administration area check program 105 in the system firmware 104 and executes it.

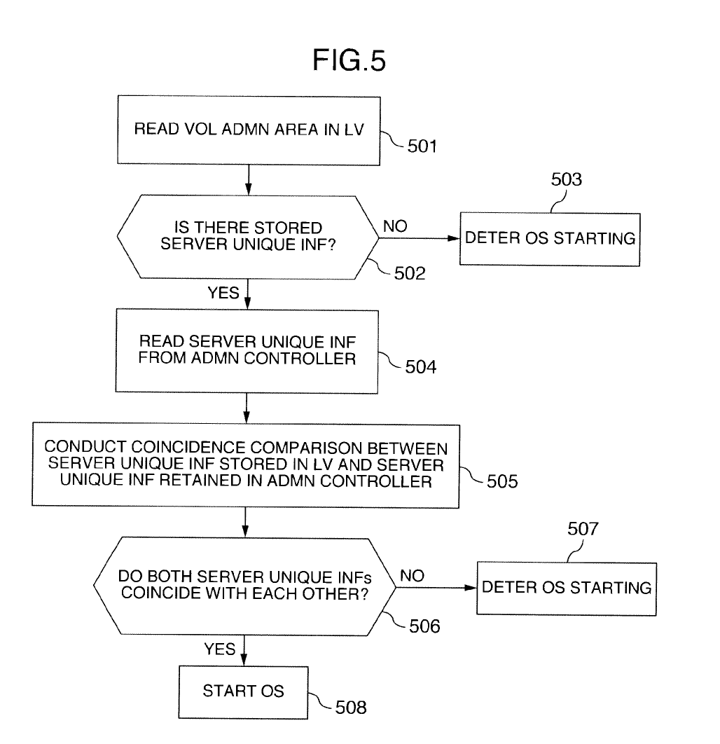

FIG. 5 shows a flow of the volume administration area check program 105.

The volume administration area check program 105 reads the volume administration area 161 in the LV 160 which is set as a starting LV of the host server 100 (step 501).

The volume administration area check program 105 makes a decision whether the volume administration area 161 which is read has server unique information (start administration information) which identifies some server (computer) stored therein (step 502).

If the volume administration area has no server unique information stored therein, then an error is output and start of an OS stored in the system area 162 in the LV 160 is deterred (step 503). However, whether to deter the OS starting at the step 503 can be changed.

If OS starting is not deterred at the step 503, then it is also possible to output a selection unit to cause the server administrator to select whether to start the OS although the volume administration area has no server unique information stored therein and start the US in response to a selection of starting the OS.

In other words, even if it is determined according to the decision made at the step 502 that the volume administration area 161 has no server unique information stored therein, the OS can be started. For example, when the host server 110 is an administration computer and a server which starts the OS stored in the system area 162 in the LV 160 is only the host server 100, the server administrator can make a selection of starting the OS in the selection unit for causing the server administrator to make a selection whether to start the OS, and thereby the server administrator can start the OS.

Even if it is determined according to the decision made at the step 502 that the volume administration area 161 has no server unique information stored therein, the LV 160 might not be an LV which is different from that intended by the server administrator, but might be an LV intended by the server administrator. If the LV 160 is in its initial state, however, server unique information is not stored in the volume administration area 161. At such a time, the server administrator may start the OS stored in the system area 162 in the LV 160.

Furthermore, if it is determined according to the decision made at the step 502 that the volume administration area 161 has no server unique information stored therein, start of the OS can be deterred fast without executing a decision made at subsequent steps 504 to 507.

If the volume administration area 161 in the LV 160 has server unique information stored therein, then server unique information administered by the administration controller 103 is read (step 504).

The volume administration area check program 105 conducts coincidence comparison between the server unique information stored in the LV 160 and the server unique information retained in the administration controller 103 (step 505). By the way, if a plurality of kinds of server unique information are registered in the LV 160, it may be made selectable whether to judge the comparison result to be coincident when all kinds of server unique information are the same or whether to judge the comparison result to be coincident when a part of kinds of server unique information is the same.

Furthermore, at the present step (step 505), a decision may be made as to correspondence between the server unique information (start administration information) stored in the LV 160 and the server unique information (identification information) which identifies the host server 100 retained in the administration controller 103.

For example, as shown in FIG. 4, a situation where there are two kinds of server unique if formation (WWN1 and UUID1) stored in the volume administration area 161 in the LV 160 is supposed. The volume administration area check program makes a decision whether each of WWN1 and UUID1 coincides with the server unique information of the host server 100.

In the case where the comparison result is judged to be coincidence when the two kinds of the server unique information stored in the volume administration area are the same as the two kinds of the server unique information of the host server 100, the host server which is about to start the OS is determined more certainly as compared with the case where the comparison result is judged on the basis of one kind of server unique information, resulting in increased solidity of the system. On the other hand, in the case where the comparison result is judged to be coincidence when either of the two kinds of server unique information is the same, flexibility of the system is increased. For example, according to the latter decision condition, starting can be conducted even if the server administrator has made a mistake when inputting either of the server unique information at the step 305 or a supposed configuration of the host server 100 is different because of replacement of the disk adapter 101.

If the result of the coincidence comparison conducted at the step 505 is judged to be coincidence at step 506, then the flow chart branches to step 508, Otherwise, the flow chart branches to step 507. Furthermore, if the server unique information (start administration information) stored in the LV 160 corresponds to the identification information which identifies the host server 100 retained in the administration controller 103 at the step 505, then the flow chart branches to the step 508. Otherwise, the flow chart branches to the step 507.

If the server unique information stored in the LV 160 coincides with the server unique information administered by the administration controller 103, then a specific area of the system area 162 in the LV 160 is read and OS start processing is begun (step 508). If they don't coincide with each other, an error is output and start of the OS stored in the system area 162 in the LV 160 is deterred (step 507).

Owing to the coincidence comparison between the server unique information stored in the volume administration area 161 in the starting LV 160 and the server unique information of the host server 100, it becomes possible to deter OS starting made from an LV which is not intended by the server administrator, as described heretofore.

In other words, the host server 110 stores the server unique information of the host server 100 into a starting LV which stores an OS scheduled to be started by the host server 100. Here, the host server 110 may be an administration server as long as it is a computer having firmware which stores the server unique information (start administration information) of the host server 100 in the starting LV (storage unit).

Before starting the OS, the host server (computer) 100 accesses an LV (storage unit) which can be referenced and for which access permission from the host server 100 is set (access setting is conducted) and makes a decision whether the LV has the server unique information (start administration information) of the host server 100 stored therein.

If the accessed storage unit has the server unique information of the host server 100 stored therein, then the host server 100 starts an OS stored in the storage unit (starting LV) which is access set. Unless the storage unit which is access set has the server unique information of the host server 100 stored therein, the host server 100 deters starting of the OS stored in the storage unit which is access set (another LV which is not the starting LV).

Furthermore, the system firmware 104 may execute one decision instead of the decisions made at the step 502 and the step 506. In the decision, the system firmware 104 judges whether the LV 160 (storage unit) which is accessed has the server unique information (start administration information) which identifies the host server 100, stored therein. If it is judged in the decision that the LV 160 has the server unique information which identifies the host server 100, stored therein, then the host server 100 starts the OS stored in the system area 162 in the LV 160. Unless it is judged in the decision that the LV 160 has the server unique information which identifies the host server 100, stored therein, an error is output and starting the OS stored in the system area 162 in the LV 160 is deterred.

Storing in an LV the server unique information of the host server scheduled to start an OS ensures association of the LV with the host server scheduled to start the OS. Even if an LV which is not desired by the server administrator is set to be capable of being referenced by the host server by a mistake of the storage administrator, it is possible owing to the association for the server administrator to know before starting the OS stored in the LV that an erroneous LV is set to be capable of being referenced by the host server. Since start of an OS which need not be started can be prevented, it can be transmitted to the storage administrator quickly that an erroneous LV is set to be capable of being referenced.

For example, when conducting a system transfer, i.e., when changing a development server (the host server 110) over to a running server (the host server 100), or when additionally installing a computer (host server 100), the computer (the host server 100) which starts the OS can start the OS certainly from an LV which stores the OS scheduled to be started, and starting of the OS from another LV can be deterred.

Furthermore, since start control is conducted before reading the system area in the LV and conducting start processing of the OS, it can be prevented to doubly start an LV which is being used by another host server.

### Second Embodiment

In the present embodiment, a case where start control utilizing information concerning the system area stored in the starting LV is implemented besides the start control utilizing the server unique information described in the first embodiment will be described.

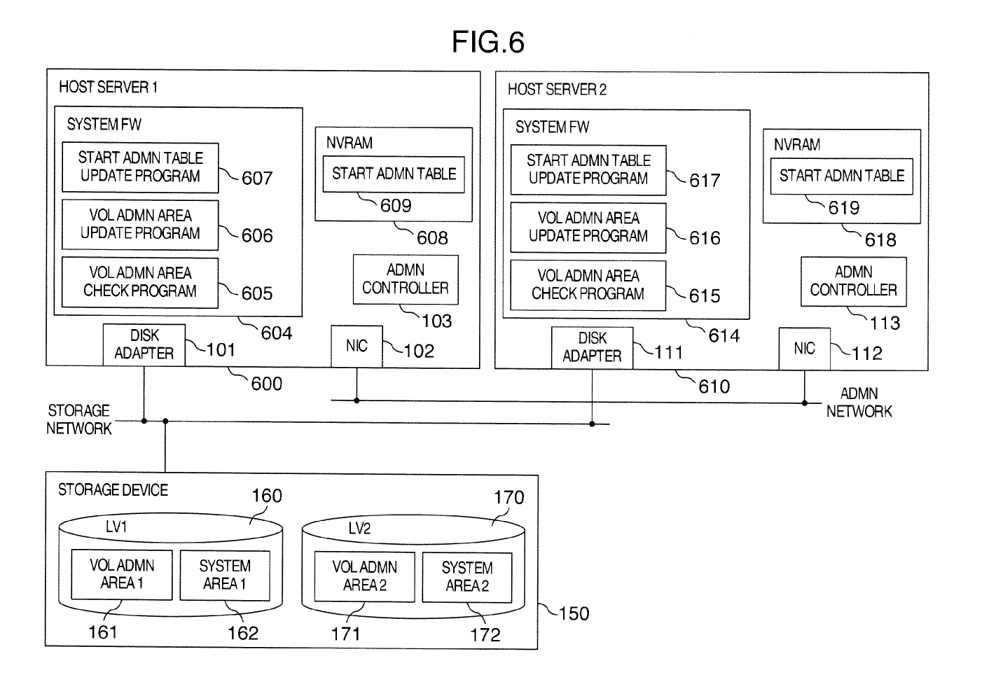

FIG. 6 is a diagram showing a configuration of a system obtained by adding NVRAMs 608 and 618, start administration tables (start administration information) 609 and 619 stored respectively in those NVRAMs, and start administration table update programs 607 and 617 stored respectively in system firmware 604 and 614 to the system configuration shown in FIG. 1 in order to conduct a coincidence judgment by utilizing the information concerning the system area in the starting LV 160 as well.

In the present embodiment, start control is exercised utilizing information other than information retained by the administration controllers 103 and 113 in order to increase the flexibility as compared with the start control in the first embodiment. In order to implement this start control, the start administration tables 609 and 619 for storing information which is not retained by the administration controllers 103 and 113 are stored in the NVRAMs 608 and 618, respectively. Furthermore, in order to update the start administration tables 609 and 619, the start administration table update programs 607 and 617 are stored in the system firmware 604 and 614 respectively.

In the ensuing description, a situation where the LV 160 which has been used in a certain host server 610 by the server administrator is used in a different host server 600 is supposed in the same way as the first embodiment.

A procedure for the server administrator to update the volume administration area 161 in the LV 160 by using a volume administration area update program 616 will now be Described. In the ensuing description, it is supposed that the server administrator previously retains server unique information of the host server 600 scheduled to start an OS and information of a system stored in the system area 162.

The system information retained by the server administrator may be detailed information of a system, an outline of the system such as names and versions of an OS and applications, or a numerical value or an abbreviated name of the system which can be discriminated by the server administrator. In the ensuing description, information of the system stored in the system area is referred to as system area information.

Points which differ from FIG. 3 when executing the volume administration area update program 616 will now be described. Information stored in the volume administration area 161 differs from that in the first embodiment in that system area information is added. Upon arrival of the volume administration area update program 616 at the step 305, therefore, an input request of the system area information concerning the system area 162 is also issued besides an input request of the server unique information of the host server 600.

In the same way, upon arrival at the step 306, information (the server unique information of the host server 600 and the system area information concerning the system area 162) which is input by the server administrator at the step 305 is overwritten in the volume administration area 161. By the way, in the present embodiment, the server unique information may not be input as long as the system area information is input.

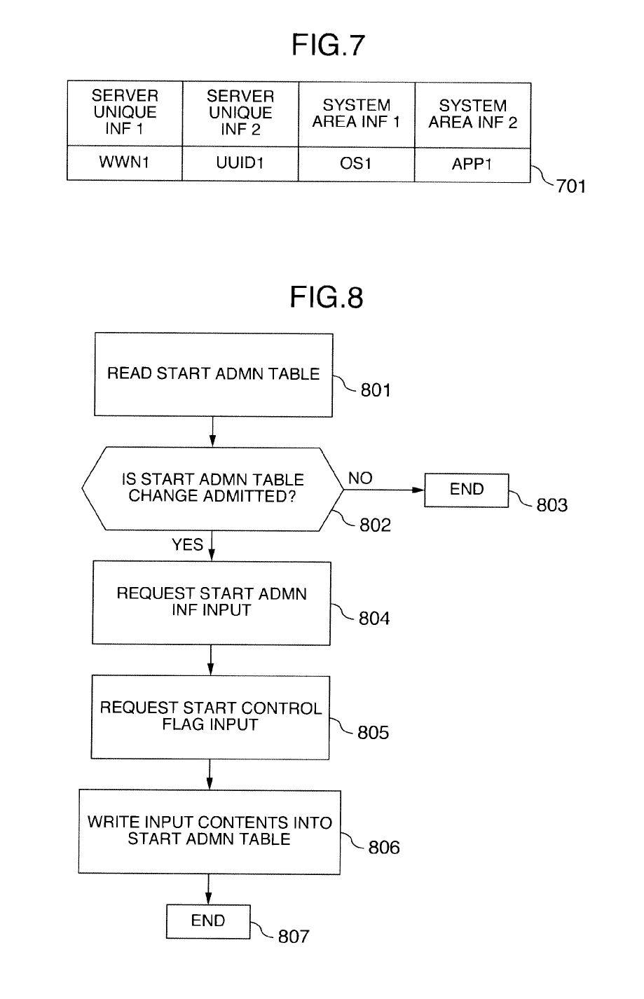

FIG. 7 shows a content example 701 of the server unique information and the system area information described in the volume administration area. As the server unique information, WWN1 and UUID1 are stored. Furthermore, as the system area information, a version OS1 of an OS stored in the system area 162 and a name APP1 of an application which is to be executed on the OS1 are stored.

A procedure for the server administrator to update the start administration table 609 by using the start administration table update program 607 in the host server 600 will now be Described.

FIG. 8 shows a flow of the start administration table update program 607.

The start administration table update program 607 reads the start administration table 609 stored in the NVRAM 608 (step 801).

The start administration table update program 607 outputs contents which are read, and outputs choices to ask whether the start administration table 609 may be changed. The server administrator may be inquired of whether the start administration table 609 may be changed (step 802).

If the change is rejected in the choices, for example, if the server administrator rejects the change, then execution of the start administration table update program 607 is finished (step 803). If the change is admitted in the choices, for example, if the server administrator admits the change, then the start administration table update program 607 outputs an input unit for inputting the start administration information (the server unique information of the host server 600 and the system area information in the LV 160 scheduled to be started). The server administrator may be caused to input the start administration information (step 804).

Before causing the server administrator to input the start administration information, the server administrator may be caused to input an administration password. By the way, if the server unique information is not used in coincidence comparison, the server administrator may not input the server unique information. In addition, the server unique information retained by the administration controller 103 may be read without causing the server administrator to input the server unique information.

The start administration table update program 607 outputs an input unit for inputting start control flag to indicate whether the start administration information which is input at the step 804 is to be used in the coincidence comparison. The server administrator may be caused to input the start control flag (step 805). It becomes possible to specify an LV desired to start in the host server 600 more explicitly, by storing start control flag in the start administration table 609.

The start administration table update program 607 overwrites the information which is input at the step 804 and the step 805, on the start administration table 609 (step 806).

It is output that writing into the start administration table 609 has been completed and the execution of the start administration table update program 607 is finished (step 807).

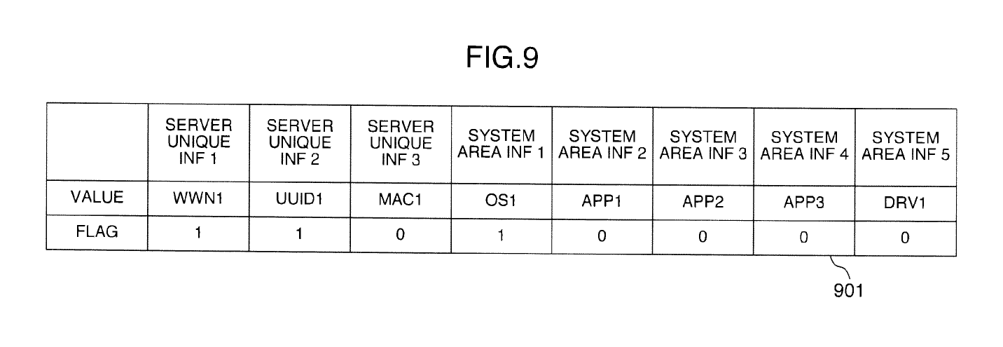

FIG. 9 shows an example of the start administration table. (Server unique information (WWN1, UUID1, and MAC1) of the host server 600, a version (OS1) of an operating system stored in the system area 162 in the LV 160, names (APP1, APP2, and APP3) of applications to be executed on the OS1 and a name (DRV1) of a driver to be used on the OS1 are stored.

In addition, a start control flag of “1” or “0” is stored for each item. If the start control flag is “1,” then the item becomes an object of coincidence comparison of the start administration information conducted at step 1005 which will be described later, and it is referred to as state in which the start control flag is set. If the start control flag is “0,” then the item is not an object of coincidence comparison, and it is referred to as state in which the start control flag is not set. In this example, items corresponding to WWN1, UUID1 and OS1 become objects of the coincidence comparison.

When the host server 600 starts an OS stored in an LV 160 which is set for starting, start administration information stored in the start administration table 609 in the host server 600 which is about to conduct starting is compared with start administration information stored in the volume administration area 161 and start control of the LV 160 is exercised. This procedure will now be described.

Upon turning on of power supply to the host server 600, the host server 600 conducts start processing such as initialization of connected devices, then reads the volume administration area check program 605 in the system firmware 604 and executes it, in the same way as the first embodiment.

Points which differ from FIG. 5 when executing the volume administration area check program 605 will now be described. The execution differs from the first embodiment in that coincidence comparison between the information in the start administration table 609 and information in the volume administration area 161 is conducted.

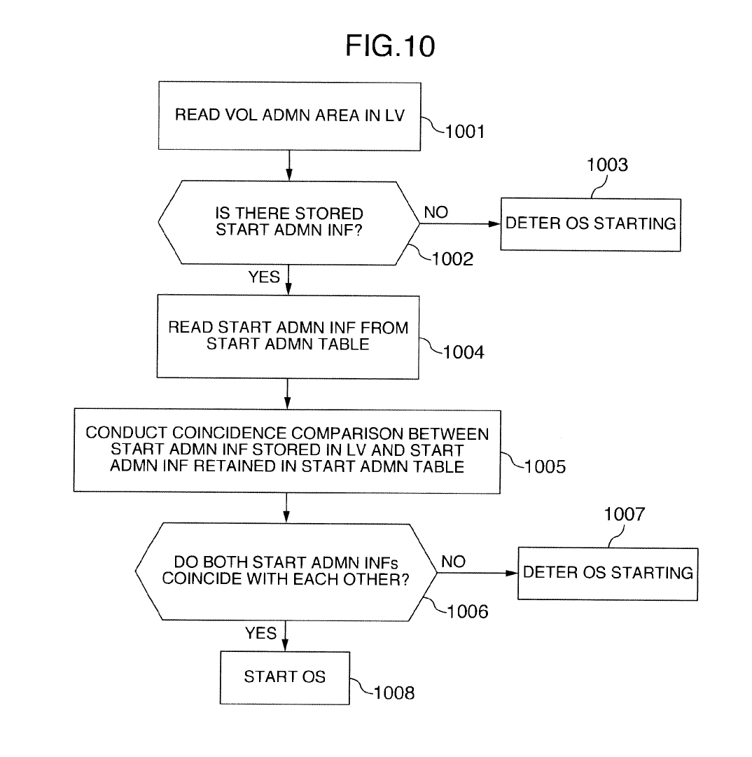

FIG. 10 shows a flow of the volume administration area check program 605.

The volume administration area check program 605 reads the volume administration area 161 in the LV 160 which is set as a starting LV of the host server 600 (step 1001).

The volume administration area check program 605 determines whether the volume administration area 161 which is read has start administration information stored therein (step 1002). If there isn't the start administration information stored therein, then an error is output and start of an OS stored in the system area 162 in the LV 160 is deterred (step 1003). However, whether to deter the OS starting at the step 1003 can be changed.

If the volume administration area 161 in the LV 160 has start administration information stored therein, then start administration information is read from the start administration table 609 stored in the NVRAM 608 (step 1004).

The volume administration area check program 605 conducts coincidence comparison between the start administration information stored in the LV 160 and the start administration information stored in the start administration table 609 (step 1005). By the way, the coincidence comparison is conducted for items having the start control flag which is set, as already described. For example, when comparing the volume administration area 161 with the start administration table 609, a decision is made whether all of WWN1, UUID1, and OS1 are included in the volume administration area 161.

If the result of the coincidence comparison conducted at the step 1005 is judged to be coincidence at step 1006, then the flow chart branches to step 1008. Otherwise, the flow chart branches to step 1007. If the start administration information stored in the LV 160 coincides with the start administration information stored in the start administration table 609, then a specific area of the system area 162 in the LV 160 is read and OS start processing is begun (step 1008). If they don't coincide with each other, an error is output and start of the OS stored in the system area 162 in the LV 160 is deterred (step 1007).

Owing to the coincidence comparison between the start administration information stored in the volume administration area 161 in the starting LV 160 and the start administration information in the start administration table 609 in the host server 600, it becomes possible to deter the host server 600 from starting an OS stored in an LV which is not intended by the server administrator, as described heretofore.

In the present embodiment, it is possible to specify an LV in which an OS or an application desired to be started is installed, by using information (such as a version of an OS or a name of an application installed in the LV) in the system area besides the server unique information. As a result, start control which is more flexible as compared with the first embodiment becomes possible.

### Third Embodiment

In the present embodiment, a case where start control utilizing an administration server (administration computer) is implemented besides the start control utilizing the server unique information and the system area information described in the second embodiment will be described

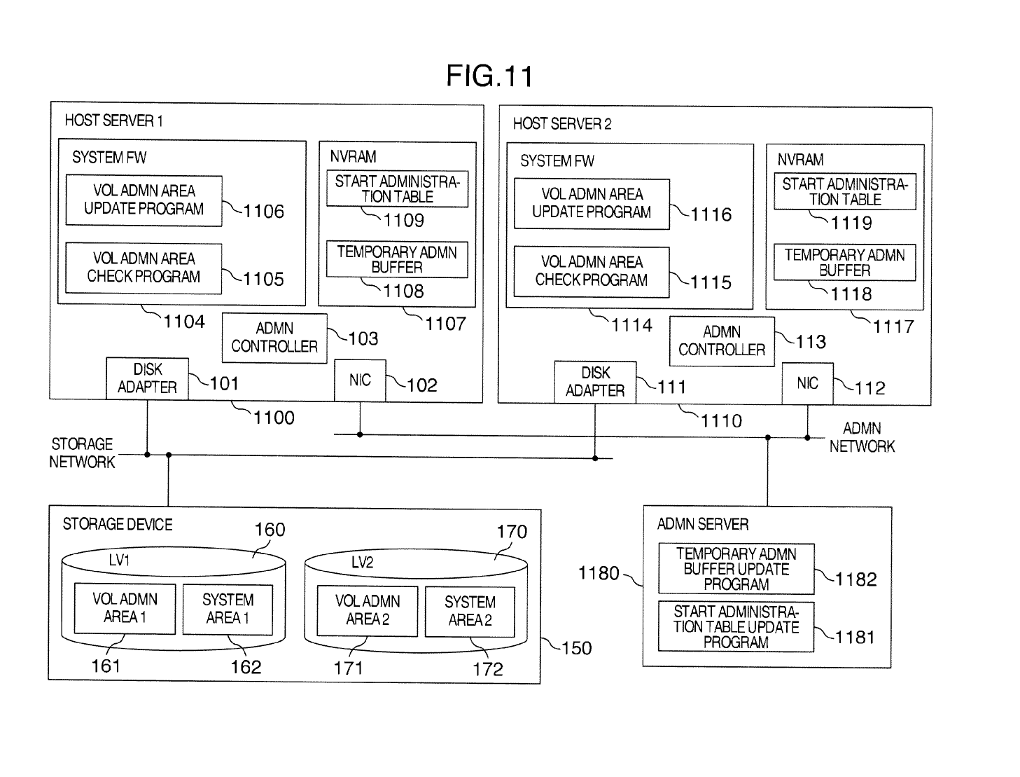

FIG. 11 is a diagram showing a configuration of a system executes start control a LV by using the administration server.

As compared with FIG. 6 showing the second embodiment, temporary administration buffers 1108 and 1118 are stored respectively in NVRAMs 1107 and 1117 and a start administration table update program 1181 is stored in an administration server 1180 together with a temporary administration buffer update program 1182. Information to be stored in the volume administration area is stored temporarily in the temporary administration buffers 1108 and 1118.

The server administrator updates the temporary administration buffers 1108 and 1118 by using the temporary administration buffer update program 1182 in the administration server 1180. Volume administration area update programs 1106 and 1116 respectively on host servers 1100 and 1110 update the volume administration area 161 in the LV 160 by using information in the temporary administration buffers 1108 and 1118. Furthermore, the server administrator updates start administration tables 1109 and 1119 by using the start administration table update program 1181.

In the present embodiment, information stored in the volume administration area 161 and information stored in the start administration table 1109 are handled on the administration server 1180. As a result, the same information can be handled. Accordingly, it becomes possible to reduce input mistakes of the server administrator.

In the ensuing description, a situation where the LV 160 which has been used in a certain host server 1110 by the server administrator is used in a different host server 1100 is supposed in the same way as the first and second embodiments.

A procedure for the server administrator to update the temporary administration buffer 1118 on the host server 1110 which can reference the LV 160, by utilizing the temporary administration buffer update program 1182 on the administration server 1180 will now be described.

In the ensuing description, it is supposed that the administration server 1180 retains server unique information of the host servers 1100 and 1110 connected to the administration network. In addition, it is supposed that the server administrator previously retains information of the system stored in the system area 162 in the same way as the second embodiment.

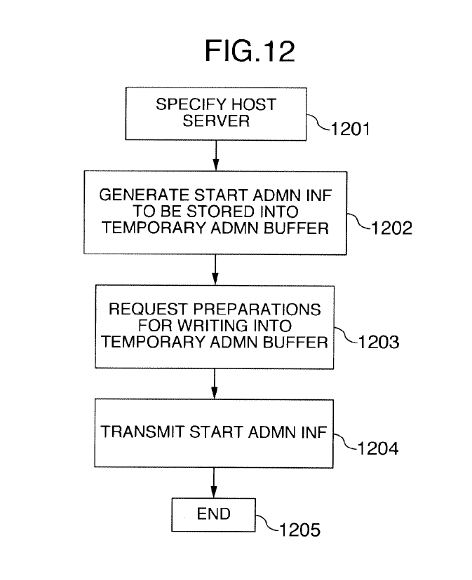

FIG. 12 shows a flow of the temporary administration buffer update program 1182.

The temporary administration buffer update program 1182 outputs a specification unit for specifying a host server having a temporary administration buffer to be updated. The server administrator may be caused to specify a host server having a temporary administration buffer to be updated (step 1201). The temporary administration buffer is used to update the volume administration area. Since the LV 160 can be referenced in the host server 1110 here, the server administrator specifies the host server 1110.

The temporary administration buffer update program 1182 generates start administration information to be stored into the temporary administration buffer 1118 (step 1202). When generating this start administration information, it is possible to cause the serer administrator to select a host server scheduled to start an OS and generate the start administration information by using server unique information of the host server, or the server administrator may be caused to input the server unique information and information of the system area 162.

Upon finishing the generation of the start administration information, the administration controller 113 in the host server 1110 is notified via the administration network that start administration information to be stored into the temporary administration buffer 1118 will be transmitted (step 1203). Upon receiving this notice, the administration controller 113 make preparations for writing start administration information which will be received at step 1204 later.

The temporary administration buffer update program 1182 transmits the generated start administration information to the host server 1110 via the administration network, and causes the administration controller 113 to write the start administration information into the temporary administration buffer 1118 (step 1204).

Completion of the transmission is output, and execution of the temporary administration buffer update program 1182 is finished (step 1205).

A procedure for storing information stored in the temporary administration buffer 1118 into the volume administration area 161 by using the volume administration area update program 1116 will now be described.

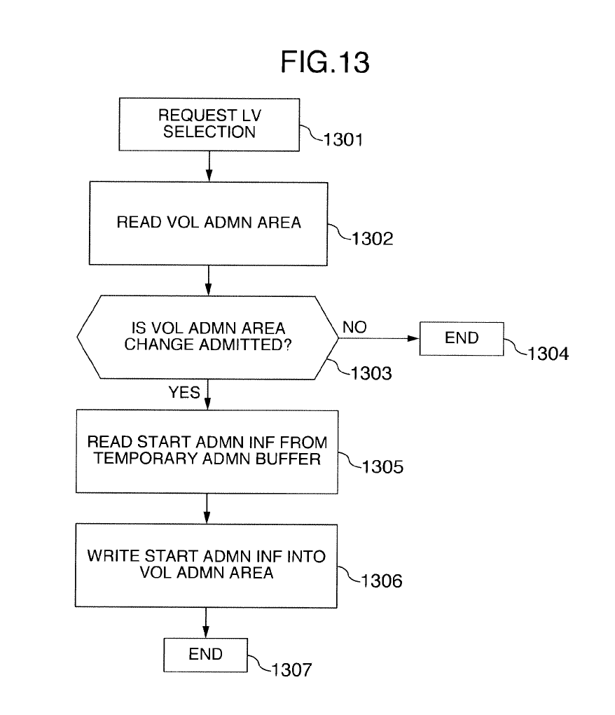

FIG. 13 shows a flow of the volume administration area update program 1116.

The volume administration area update program 1116 outputs a list of LVs which can be referenced from the host server 1110, and outputs a selection unit for causing selection of an LV having the volume administration area 161 to be updated. The server administrator may be caused to select an LV having the volume administration area 161 to be updated (step 1301). Since it is now supposed that the LV 160 can be referenced from the host server 1110, the LV 160 is displayed. The volume administration area update program 1116 reads the volume administration area 161 stored in the LV 160 which is selected by using the selection unit (step 1302).

The volume administration area update program 1116 outputs contents which have been read, and outputs choices to ask whether the volume administration area 161 may be changed. The server administrator may be inquired of whether the volume administration area 161 may be changed (step 1303).

If the change is rejected in the choices, for example, if the server administrator rejects the change, then execution of the volume administration area update program 1116 is finished (step 1304).

If the change is admitted in the choices, for example, if the server administrator admits the change, then the volume administration area update program 1116 reads information stored in the temporary administration buffer 1118 (step 1305).

The volume administration area update program 1116 writes the information which has been read, into the volume administration area 161 in the LV 160 which can be referenced (step 1306).

Completion of writing is output, and execution of the volume administration area update program 1116 is finished (step 1307).

In this way, it is possible to store information generated on the administration server 180 into the volume administration area 161 in the LV 160 through the flows shown in FIG. 12 and FIG. 13.

A procedure for updating the start administration table 1109 by using the start administration table update program 1181 on the administration server 1180 will now be described. By the way, the update procedure of the start administration table 1109 is similar to the update procedure of the temporary administration buffer 1118 shown in FIG, 12.

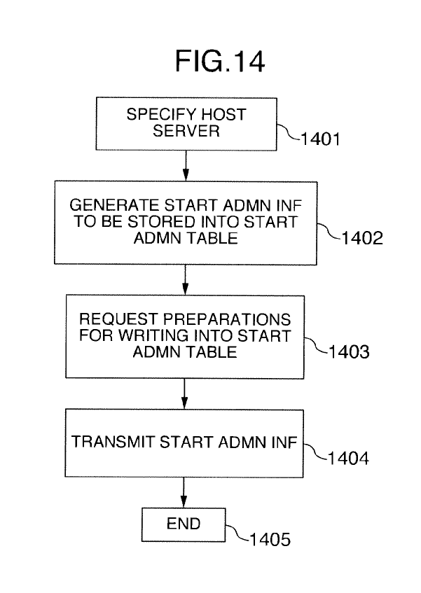

FIG. 14 shows a flow of the start administration table update program 1181.

The start administration table update program 1181 outputs a specification unit for specifying a host server having a start administration table to be updated. The server administrator may be caused to specify a host server having a start administration table to be updated (step 1401). Since the host server 1100 is scheduled to be started, the server administrator specifies the host server 1100. The start administration table update program 1181 generates start administration information to be stored into the start administration table 1109 (step 1402). When generating this start administration information, it may be generated by using the server unique information of the host server 1100, or the server administrator may be caused to input the server unique information and information of the system area 162. It is also possible to cause contents generated when executing the temporary administration buffer update program 1182 to be retained in the administration server 1180 and use the contents. Furthermore, the start control flags may be stored in the same way as the second embodiment.

Upon finishing the generation of the start administration information, the administration controller 103 in the host server 1100 is notified via the administration network that start administration information to be stored into the start administration table 1109 will be transmitted (step 1403). Upon receiving this notice, the administration controller 103 make preparations for writing start administration information which will be received at step 1404 later.

It is also possible to receive information of the start administration table 1109 before update, display the start administration table 1109, and inquire of the server administrator whether the start administration table may be updated, in the same way as the second embodiment.

The start administration table update program 1181 transmits the generated start administration information to the host server 1100 via the administration network, and causes the administration controller 103 to write the start administration information into the start administration table 1109 (step 1404).

Completion of the transmission is output and execution of the start administration table update program 1181 is finished (step 1405).

A difference of the flow of the start control in the present embodiment as compared with that in the second embodiment shown in FIG. 10 will now be described. Upon turning on of power supply to the host server 1100, the volume administration area program 1106 executes coincidence comparison between the start administration information stored in the volume administration area 161 in the LV 160 which is set as the starting LV and the start administration information stored in the start administration table 1109.

Since coincidence comparison between the start administration information stored in the volume administration area 161 in the starting LV 160 and the start administration information stored in the start administration table 1109 on the host server 1100 is conducted as described heretofore, it becomes possible to deter the host server 1100 from starting an OS stored in an LV which is not intended by the server administrator.

In the present embodiment, start administration information is handled in the administration server 1180, and consequently similar administration information can be stored in the volume administration area 161 and the start administration table 1109. As a result, it becomes possible to reduce input mistakes of the server administrator.

In addition, it is also possible that the host server 1100 is the administration server (administration computer) and the host server 1110 transmits start administration information to the host server 1100

### Fourth Embodiment

In the present embodiment, a case where start control utilizing start administration information described in the first to third embodiments is implemented on virtual servers will be described.

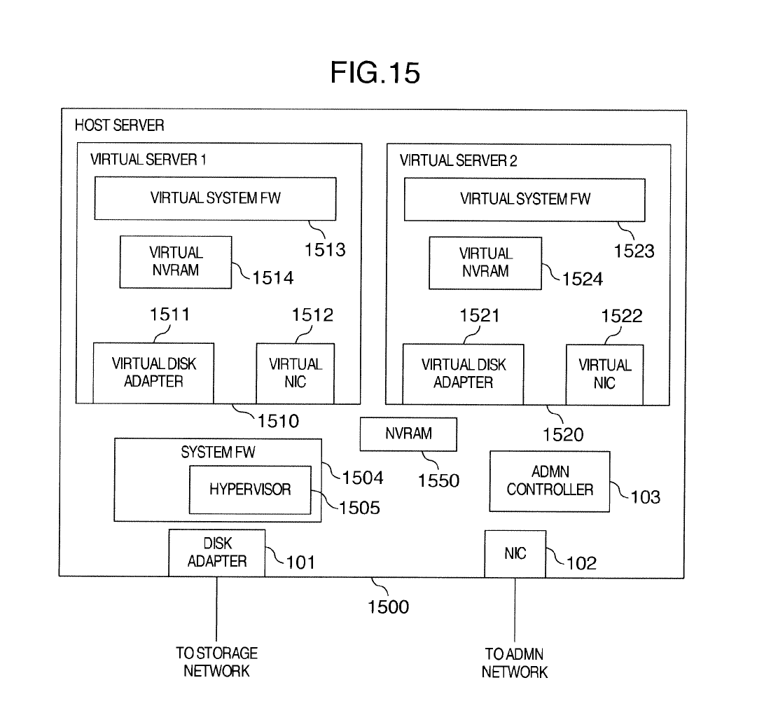

FIG. 15 shows a configuration which makes it possible for a virtual server to start an OS stored in an LV which is specified as a starting LV. A system in which start restriction is conducted on virtual servers 1510 and 1520 can be implemented if virtual system firmware 1513 and 1523 are configured to execute flows shown in the first to third embodiments. Although not illustrated in FIG. 15, a volume administration area update program and a volume administration area check program are stored in each of the virtual system firmware 1513 and 1523.

The host server 1500 executes a hypervisor 1505, and executes the virtual servers 1510 and 1520 on the hypervisor 1505. Although two virtual servers are shown in FIG. 15, three or more virtual servers may exist.

First, an example of a case where a flow similar to that in the first embodiment is implemented on the virtual server 1510 will now be described.

The hypervisor 1505 administers states of a virtual disk adapter 1511, a virtual NIC 1512, and the virtual system firmware 1513 which are executed on the virtual server 1510. Furthermore, the hypervisor 1505 retains server unique information in the virtual host server 1510 such as a virtual WWN given to the virtual disk adapter 1511, a virtual MAC address given to the virtual NIC 1512, and a virtual UUID given to the virtual system firmware 1513. The server unique information can be referenced from the virtual system firmware 1513.

A difference between execution of the flows shown in FIG. 3 and FIG. 5 on the virtual system firmware 1513 and execution of them on the system firmware 1504 in the host server 1500 will now be described. The difference from the case where execution of the flows is implemented on the host server 1500 is that the server unique information of the virtual server 1510 is administered by the hypervisor 1505.

At the step 504, therefore, the volume administration area check program on the virtual system firmware 1513 does not read the server unique information from the administration controller 103 but reads the server unique information from the hypervisor 1505.

It becomes possible to deter the virtual server 1510 from starting an OS stored in an LV which is not intended by the server administrator, by conducting the coincidence comparison between the server unique information stored in the volume administration area in the starting LV and the server unique information of the virtual server 1510 in the same way as the first embodiment, as described heretofore.

An example of a case where a flow similar to that in the second embodiment is implemented on the virtual server 1510 will now be described. Although not illustrated in FIG. 15, a program for reading and writing a start administration table similar to the start administration table update programs 607 and 617 described in the second embodiment is stored in the virtual system firmware 1513.

The hypervisor 1505 provides the virtual servers 1510 and 1520 with virtual NVRAMs 1514 and 1524 to make it possible to access them on the virtual servers 1510 and 1520.

Start administration tables for all virtual servers 1510 and 1520 are stored in an NVRAM 1550. The hypervisor 1505 distributes the start administration tables in the NVRAM 1550 to the virtual servers 1510 and 1520, and stores the distributed start administration tables into virtual NVRAMs 1514 and 1524.

The program for reading and writing the start administration table in the virtual system firmware 1513 reads/writes start administration information from into a start administration table stored in the virtual NVRAM 1514 or 1524. By the way, the server unique information of the virtual server 1510 is read from the hypervisor 1505 as already described.

Processing of start control can be implemented by executing the flows shown in FIG, 8 and FIG. 10 in the same way as the second embodiment.

It becomes possible to deter the virtual server 1510 from starting an OS stored in an LV which not intended by the server administrator, by using start administration information in the same way as the second embodiment in this way.

In addition, a case where a flow similar to that in the third embodiment is implemented on the virtual server 1510 will now be described.

Start administration tables and temporary administration buffers for all virtual servers 1510 and 1520 are stored in the NVRAM 1550. The hypervisor 1505 distributes the start administration tables and temporary administration buffers in the NVRAM 1505 to the virtual servers 1510 and 1520, and stores the distributed start administration tables and temporary administration buffers into the virtual NVRAMs 1514 and 1524.

Processing of start control can be implemented by executing the flows shown in FIG. 12, FIG. 13, and FIG. 14 in the same way as the third embodiment.

It becomes possible to deter the virtual server 1510 from starting an OS stored in an LV which is not intended by the server administrator, by using the administration server in the same way as the third embodiment in this way.

It becomes possible to deter the virtual server 1510 from starting an OS stored in an LV which is not intended by the server administrator, by conducting on the virtual host server 1510 the coincidence comparison between the start administration information stored in the volume administration area in the starting LV and the start administration information in the start administration table in the virtual host server 1510, as described heretofore.

By the way, restrictions on start conducted by the host server or the virtual server may be executed by combining parts of the methods described in the first to fourth embodiments described heretofore.

An example of a computer system starting method are shown below.

1. A computer system starting method for starting a computer system having a plurality of computers and a storage unit which stores an operating system to be started in some computer,
a first computer storing start administration information which identifies the some computer into the storage unit; and
a second computer accessing a storage unit which can be referenced from the second computer, making a decision whether the accessed storage unit has start administration information identifying an own computer stored therein, and starting the operating system stored in the accessed storage unit, when the accessed storage unit is judged according to the decision to have start administration information identifying an own computer stored therein.

2. The computer system starting method according to item 1, wherein
the second computer executes a first decision to make a decision whether the accessed storage unit has start administration information which identifies the some computer stored therein, and executes a second decision to make a decision whether the start administration information which identities the some computer corresponds to identification information which identifies the own computer, when the accessed storage unit is judged according to the first decision to have start administration information which identifies the some computer stored therein, and
the second computer judges that the accessed storage unit has start administration Information which identities the own computer stored therein, when the start administration Information which identities the some computer is judged according to the second decision to correspond to the identification information.

3. The computer system start starting method according to item 2, wherein
the storage unit has a system area and a volume administration area,
the first computer stores start administration information which identities the second computer into a volume administration area of a storage unit having a system area where an operating system to be started in the second computer is stored,
the second computer makes a decision whether a volume administration area of the accessed storage unit has start administration information which identifies the some computer stored therein as the first decision, and
the second computer executes the second decision, when a volume administration area of the accessed storage unit is judged according to the first decision to have start administration information which identifies the some computer stored therein.

4. The computer system starting method according to item 2, wherein the second computer deters start of the operating system stored in the accessed storage unit, when the accessed storage unit is judged according to the first decision not to have start administration information which identifies the some computer stored therein, or when start administration information stored in the accessed storage unit is judged according to the second decision not to correspond to the identification information which identifies the own computer.

It should be further understood by those skilled in the art that the foregoing description has been made on embodiments of the invention and that various changes and modifications may be made in the invention without departing from the spirit of the invention and the scope of the appended claims.

1. A computer system comprising:
a storage unit connected to a plurality of computers, an operating system to be started in some computer being stored in the storage unit;
a first computer having firmware which stores start administration information identifying the some computer into the storage unit; and
a second computer having firmware for making a decision whether the storage unit which is accessed has start administration information identifying an own computer stored therein, the operating system stored in the accessed storage unit being started by the second computer, when the storage unit which is accessed is judged according to the decision to have start administration information identifying an own computer stored therein.

2. The computer system according to claim 1, wherein
the firmware in the second computer executes a first decision to make a decision whether the accessed storage unit has start administration information which identifies the some computer stored therein, and executes a second decision to make a decision whether the start administration information which identifies the some computer corresponds to identification information which identifies an own computer, when the accessed storage unit is judged according to the first decision to have start administration information which identifies the some computer stored therein, and
the firmware in the second computer judges that the accessed storage unit has start administration information which identifies the own computer stored therein, when the start administration information which identifies the sonic computer is judged according to the second decision to correspond to the identification information.

3. The computer system according to claim 2, wherein
the storage unit is a logical volume obtained by logically dividing a storage area of a storage device connected to the plurality of computers, and the storage unit has a system area where an operating system to be started by the some computer is stored and a volume administration area where start administration information which identifies the some computer is stored by the first computer, and
the accessed storage unit is a logical volume for which an access permission from the second computer is set.

4. The computer system according to claim 3, wherein the second computer deters start of an operating system stored in the accessed storage unit, when the accessed storage unit is judged according to the first decision not to have start administration information which identifies the some computer stored therein.

5. The computer system according to claim 3, wherein the second computer deters start of an operating system stored in the accessed storage unit, when start administration information stored in the accessed storage unit is judged according to the second decision not to correspond to the identification information.

6. The computer system according to claim 3, wherein start administration information which identities the second computer comprises at least some of an identifier unique to the second computer, an identifier unique to a disk adapter included in the second computer, an identifier unique to an interface card included in the second computer, an identifier of the operating system to be started by the second computer, an identifier of an application to be executed on the operating system, and an identifier of a driver to be used on the operating system.

7. The computer system according to claim 3, wherein the computer system comprises an administration computer which transmits start administration information identifying the second computer to the first computer and which transmits the identification information to the second computer.

8. The computer system according to claim 3, wherein the first computer transmits the identification information to the second computer.

9. The computer system according to claim 3, wherein
the second computer has a plurality of kinds of the identification information and start control flags given to the kinds of the identification information, and
the firmware in the second computer makes a decision as to correspondence between the identification information given the start control flags and start administration information stored in the accessed storage unit, as the second decision.

10. The computer system according to claim 3, wherein
the second computer is a virtual computer on a hypervisor included in a physical computer,
the hypervisor has identification information which identifies the second computer, and
the second computer acquires identification information which identifies the second computer from the hypervisor.

11. The computer system according to claim 3, wherein the second computer presents an error, when the accessed storage unit is judged according to the first decision not to have start administration information which identifies the some computer stored therein, or when start administration information stored in the accessed storage unit is judged according to the second decision not to correspond to the identification information.

12. A computer comprising:
a disk adapter connected to a storage unit; and
firmware for making a decision whether the storage unit which is accessed has start administration information identifying an own computer stored therein, and starting an operating system stored in the accessed storage unit, when the storage unit which is accessed is judged according to the decision to have start administration information identifying the own computer stored therein.

13. The computer according to claim 12, wherein
the firmware executes a first decision to make a decision whether the accessed storage unit has start administration information which identifies the own computer or another computer stored therein, and executes a second decision to make a decision whether the start administration information which identifies the own computer or another computer corresponds to identification information which identifies the own computer, when the accessed storage unit is judged according to the first decision to have start administration information which identifies the own computer or another computer stored therein, and
the firmware judges that the accessed storage unit has start administration information which identifies the own computer stored therein, when the start administration information which identifies the own computer or another computer is judged according to the second decision to correspond to the identification information.

14. The computer according to claim 13, wherein the operating system stored in the accessed storage unit is deterred from being started, when the accessed storage unit is judged according to the first decision not to have start administration information which identifies the own computer or another computer stored therein, or when start administration information stored in the accessed storage unit is judged according to the second decision not to correspond to the identification information.

15. The computer according to claim 13, wherein an error is presented, when the accessed storage unit is judged according to the first decision not to have start administration information which identifies the own computer or another computer stored therein, or when start administration information stored in the accessed storage unit is judged according to the second decision not to correspond to the identification information.
